(19) United States
(12) Patent Application Publication
(10) Pub. No.: US 2008/0103788 A1
(43) Pub. Date: May 1, 2008

(54) SYSTEM, METHOD AND PROGRAM PRODUCT FOR PREDICTING COMMERCIAL OFF-THE-SHELF EQUIPMENT RELIABILITY

(75) Inventors: Russell W. Morris, Redmond, WA (US); Carl W. Schilling, Federal Way, WA (US)

Correspondence Address: LAW OFFICE OF CHARLES W. PETERSON, JR. -- BOEING, 435B Carlisle Dr., Herndon, VA, 20170, US

(73) Assignee: THE BOEING COMPANY, Chicago, IL (US)

(21) Appl. No.: 11/554,793

(22) Filed: Oct. 31, 2006

(51) Int. Cl. G06Q 10/00; G07G 1/00; G06F 17/30; G06Q 30/00

(52) U.S. Cl. 705/1; 705/10

(57) ABSTRACT

A system, method and program product for predicting equipment reliability, especially for off-the-shelf equipment. Selected off-the-shelf equipment is distilled into fundamental elements, e.g., assemblies and components in the assemblies. Reliability statistics are gathered for assemblies and components in analogous equipment. Coefficients are generated to map the reliability statistics for the assemblies and components to intended uses and environments for the selected off-the-shelf equipment. Reliability statistics that are traceable and repeatable are generated for the selected off-the-shelf equipment based on the mapped assembly and component reliability statistics.

### STATEMENT REGARDING FEDERALLY SPONSORED RESEARCH OR DEVELOPMENT

This invention was made with Government support under Government contract No. F19628-01-D-0016 awarded by the U.S.A.F, AWACS program. The Government has certain rights in this invention.

### BACKGROUND OF THE INVENTION

1. Field of the Invention

The present invention generally relates to reliability or mission assurance and, more particularly, relates to mission reliability, logistic reliability, and other reliability related attributes for Commercial Off-the-Shelf (COTS) equipment or equipment including or made from COTS components.

2. Background Description

Currently, manufacturers provide very little reliability information for equipment intended for distribution and sales as Commercial Off-the-Shelf (COTS) equipment. Often COTS equipment carries little more than an initial warranty or reliability numbers of unknown traceability or pedigree. COTS computer systems, for example, have warranties of as little as ninety (90) days up to, perhaps, one (1) or two (2) years. This factory warranty provides very little reliability information, failing to provide, for example, infant mortality (early failure rate), life expectancy, mean time between fails (MBTF), much less any indication of what internal system component may be likely to fail and when. This reliability information is needed for estimating spares, the expected number of maintenance actions, and the costs associated with supporting the equipment once in the field, i.e., in a private home, an office, an aircraft, spacecraft, or even in a mobile environment.

Frequently in certain applications, COTS equipment could satisfy government needs, though it may not necessarily meet government contractual requirements. COTS equipment may fall short of governmental requirements because insufficient data is available to assure adequate system reliability and meet support and repair needs. This shortfall may result because without adequate reliability statistics (i.e., field failure statistics), one cannot estimate maintenance and repair costs and resources or maintain an adequate supply of spares/replacements with any degree of certainty.

Consequently, previous approaches resorted to using available data and a number of gross assumptions to estimate the reliability. For military applications for example, the available data was not typically based on similar operating conditions and the gross assumptions were too widely estimated to provide any reasonable accuracy or consistency. As a result, various programs suffered wildly divergent product reliability estimates and subsequent estimating errors in costs and schedules.

Accordingly, there is a need for detailed and accurate reliability data for COTS equipment and, more particularly for a way to determine accurate reliability data for COTS equipment.

### SUMMARY OF THE INVENTION

An embodiment of the present invention includes a system, method and program product for predicting equipment reliability, especially for off-the-shelf equipment. Selected off-the-shelf equipment is distilled into fundamental elements, e.g., assemblies and components in the assemblies. Reliability statistics are gathered for assemblies and components in analogous equipment. Coefficients are generated to map the reliability statistics for the assemblies and components to intended uses and environments for the selected off-the-shelf equipment. Reliability predictions or estimates are generated for the selected off-the-shelf equipment based on the mapped assembly and component reliability statistics.

Advantageously, reliability statistics may be generated for the COTS equipment by dividing reliability statistics for the analogous equipment by the weighted sum. Thereafter, usage and environmental parameter documentation are collected and maintained to subsequently allow for quickly generating consistent, repeatable estimates. A new reference environment may be applied to assemblies and/or components, as desired, to assess k-factors (reliability statistic mapping coefficients) for a new or intended environment without re-distilling the equipment into components and regenerating k-factors each time. Multiple parameter factors may be adjusted to vary the COTS reliability estimate based on, for example, engineering assessments (e.g., development data), handbook data (e.g., Non Electronic Parts Data 1995, Reliability Assembly in Certification, Rome, N.Y.) and other information related to the operational and or environmental usage profile.

Further, once COTS reliability estimates are generated, model data may be provided to appropriate organizations for assessment. Typical such assessments include, for example, assessments against customer requirements, logistics impact safety, mission reliability, developmental contract cost and schedule to perform estimates and overall systems effectiveness.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of a Commercial Off-the-Shelf (COTS) component reliability prediction system according a preferred embodiment of the present invention.

FIG. 2 shows and example 120 of steps in generating reliability data for identified COTS equipment.

### DETAILED DESCRIPTION OF THE INVENTION

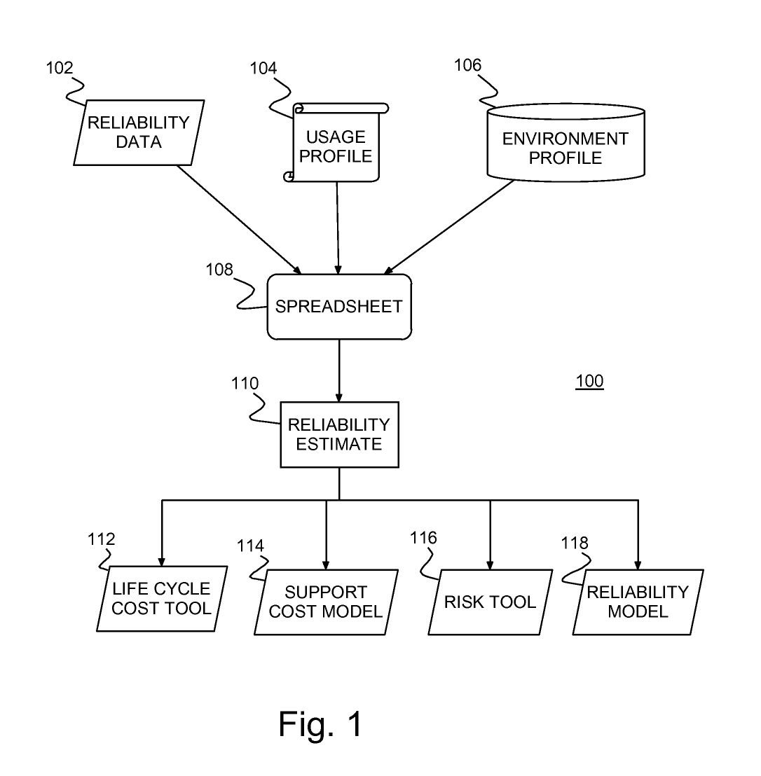

Turning now to the drawings and more particularly, FIG. 1 shows an example of a Commercial Off-the-Shelf (COTS) equipment reliability prediction system 100 according a preferred embodiment of the present invention. The present invention provides for the repeatable, traceable and accurate reliability estimates of COTS equipment usable, for example, in commercial and military aerospace programs. As used herein, a manufacturer produces equipment for off-the-shelf sales. For convenience of discussion herein, each piece of equipment includes one or more assemblies. Each assembly includes components that may include one or more sub-components. Assemblies in typical computer system may include, for example, a power supply, a microprocessor card or motherboard, an input/output (I/O) or peripheral card, a display adapter, a display, one or more memory cards, power source(s), cooling and some form of non-volatile storage, e.g., a hard disk drive. Components in these assemblies may include, for example, printed circuit (PC) cards, a microprocessor, a display driver chip, an I/O driver chip, memory chips, the display (cathode ray tube (CRT), a liquid crystal diode (LCD) display or plasma screen display) miscellaneous system electronics, power supply(ies), cooling and system mechanical components, e.g., the disk drive actuator and disk media. Public, military and/or vendor data is collected for assembly components and used to provide adjustment factors or coefficients (referred to as k-factors) for mapping reliability statistics for analogous equipment to generate COTS equipment reliability data. Generated reliability data may be used to provide equipment support for the COTS equipment, e.g., assembly and/or component sparing.

More particularly, the preferred COTS equipment reliability prediction system 100 derives k-factors for each piece of COTS equipment. The k-factors are basic design-to-environment reliability attributes that may be derived from reliability data for analogous equipment, assembly, and component, i.e., for assemblies and components associated with like and similar equipment in comparable environments and comparable usage profiles. Each k-factor may be both environment and usage dependent and so, may be different for each piece of equipment and for each assembly, and component within each piece. Then, for each COTS equipment the COTS reliability prediction system 100 applies the k-factors to equipment assemblies, and components to determine how operation outside of the originally intended environment may affect reliability of the particular COTS equipment. Thus, each major assembly and/or component is assessed based on planned equipment usage and environmental profiles.

Preferably, the COTS reliability prediction system 100 uses reliability data 102 from public sources for generating k-factors, e.g., published reliability data in component data manuals. Usage profiles 104 and environmental profiles 106 are collected for analogous equipment, assemblies, and components and are stored, e.g., locally or in remote storage, and provided to a typical state of the art spreadsheet application 108, e.g., Excel™ or Access™, on a state of the art computer, e.g., a PC, a notebook computer, a handheld computer, or a personal digital assistant (PDA). Alternately, usage profiles 104 and environmental profiles 106 may be generated from raw data and provided directly to the spreadsheet 108. The spreadsheet 108 generates a reliability estimate 110 that may be used in quality assessment tools 112, 114, 116 and 118 for product planning and management (e.g., determining how many spares of each assembly and component should be kept available in stock) and system reliability (e.g., determining an equipment support budget and end-of-life for equipment replacements and/or changeovers). So, the quality assessment tools 112, 114, 116 and 118 may include, for example, a life cycle cost tool 112, a support cost model 114, a risk assessment tool 116 and a reliability model 118.

K-factors may be generated, for example, from data from a suitable source such as the Reliability Information Analysis Center (RIAC, e.g., URL quanterion.com/RIAC/), e.g., a Systems Reliability Handbook or the “Systems Reliability Toolkit.” Also, k-factors may be generated from commercial data, collected from internal operations and/or from any other generally recognized source. For example, electronic component and Integrated Circuit (IC) manufacturers typically publish reliability data in advance sheets and IC data manuals. K-factors also are developed based on usage and intended operating environment, e.g., space, in an airborne inhabited cargo platform, or in an airborne inhabited fighter. So, usage profiles 104 include, for example, known unit reliability profiles and environmental assessment results, e.g., statistical characterizations of on/off cycles and intended use. Similarly, environmental profiles 106 include, for example, known or measured unit reliability profiles, e.g., statistical characterizations for vibrations, transportation effects, acoustics, shock, temperature (both operating and storage), humidity (relative and/or absolute), sand and dust, salt air/water, and fungus. Preferably, for military applications the environmental profiles 106 indicate a degree of design sensitivity to each of the environmental elements normalized for a military design, i.e., with the military design as unity.

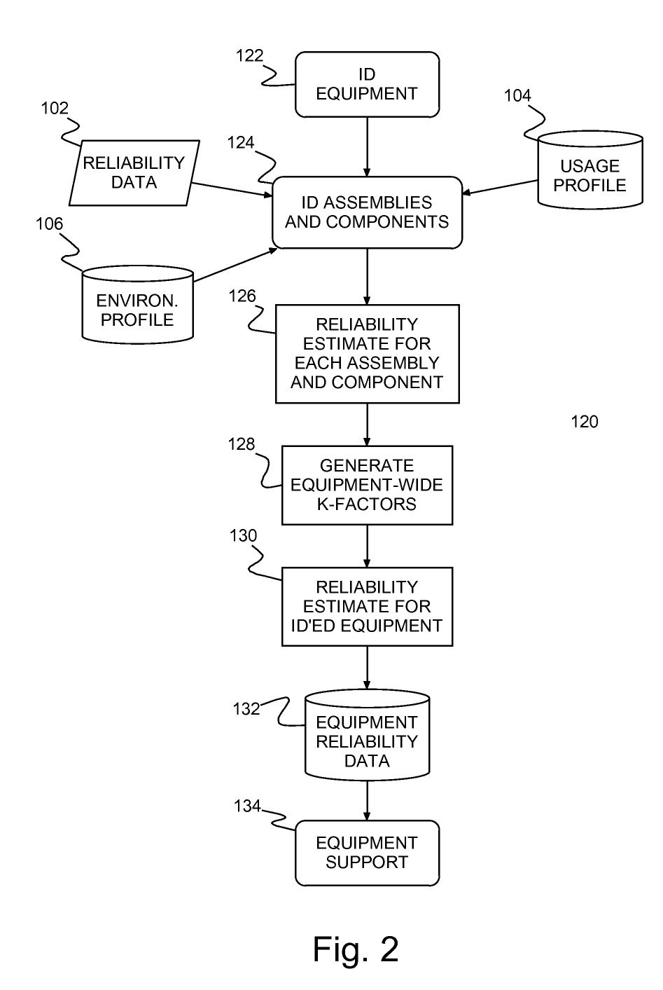

FIG. 2 shows an example 120 of steps in generating reliability data for COTS equipment according to a preferred embodiment of the present invention with reference to the system of FIG. 1 with like elements labeled identically. In step 122 COTS equipment is identified/selected for analysis. In step 124 the identified equipment is distilled into assemblies and then into components. Reliability data 102 is retrieved for each component. Also, appropriate usage profiles 104 and environmental profiles 106 are selected. In step 126 reliability estimates are generated for each of these components and, optionally, assemblies. Then, in step 128 k-factors are generated for the equipment based on the reliability data for each relevant component and/or assembly. In step 130 a reliability estimate is generated for the equipment from the k-factors and from relevant usage profiles 104 and environmental profiles 106. The resulting reliability data are made available in step 132 for quality assessments, e.g., by quality assessment tools 112, 114, 116 and 118 in FIG. 1. Finally, in step 134 the reliability data and quality assessments are used to manage system support for the identified equipment. Returning to FIG. 1, for example, reliability data may be provided to the appropriate organizations for assessing equipment reliability against customer requirements, impact to the logistics, mission reliability, and developmental costs. Thus, these assessments may be used in step 134 for scheduling, for example, to schedule contract performance targets, overall systems effectiveness and equipment replacements.

So, after identifying candidate COTS equipment in step 122, the identified equipment is distilled into its elemental building blocks in step 124, i.e., broken down next into smaller subsystem elements or assemblies and components. These major assemblies may be listed in a table. As noted hereinabove, for a computer system these components may include, for example, a microprocessor, a display driver chip, an I/O driver chip, memory chips, the display cathode ray tube (CRT), miscellaneous system electronics, and system mechanical components, e.g., the disk drive actuator and disk media. Available statistics may be applied against each assembly and/or component. Available statistics may be collected, for example, from an approximate distribution of failures from previously completed failure modes and effects analyses or from off-the-shelf data manuals. Since the intended operating environment and usage may be much different from that in which the available data was collected, a base reliability estimate is determined by assessing each identified assembly and/or component against a comparable or an identical assembly and/or component operating in like and similar equipment and environments.

An analogous computer system, for example, may have a 4% failure rate associated with the microprocessor motherboard, 25% with memory cards, and 20% with general electronic devices. An original operational environment, or baseline environment, is established for the analogous unit and a change for association with a new or intended operational environment is determined. A typical COTS computer system, for example, is designed for an office environment that is essentially vibration free with eight hours on and sixteen off. By contrast in an intended mobile application, e.g., in an automobile or for a military or space based environment, the COTS computer system may be expected to run continuously or very intermittently, and experience significant vibration, e.g., from the terrain, and/or from the vehicle itself. Thus, component results predicated on assessed operational differences and differences in the general exposure environments for the particular equipment may indicate that an overall assembly adjustment is necessary.

In another example, a file server contains general electronics (e.g., bus drivers, field programmable logic arrays (FPLAs), and random logic gates), a microprocessor, a power supply with high and low power components, memory and multiple disk drives. The difference in file server reliability between an original operating environment and a new harsher environment, however, can vary with each particular assembly and component. The operating environment may be most significant for mechanical component reliability, such as for the disk drives, with a k-factor in excess of 4 times for vibrational effects. A much lower k-factor may apply for temperature, e.g., on the order of 2 times. Thus, individual k-factors are individually determined for each potentially significant reliability parameter. Then, preferably, a weighted k-factor sum is determined by summing the k-factors for the particular equipment and dividing the sum by the total number of changed factors. So, the sum is divided by the number of k-factors that have changed for the equipment as the result of operating parameter changes. This weighted sum may be applied to reliability data for the analogous equipment to estimate the new operational usage reliability for the identified COTS equipment.

Advantageously, reliability statistics may be generated for the COTS equipment by dividing reliability statistics for the analogous equipment by the weighted sum. So, the mean time between failures (MTBF) may be generated, for example, by dividing the weighted sum into the original estimated MTBF for the analogous equipment. Thereafter, usage and environmental parameter documentation 104, 106 are collected and maintained to subsequently allow for quickly generating consistent, repeatable estimates. A new reference environment may be applied to assemblies and/or components, as desired, to assess k-factors for a new or intended environment without re-distilling the equipment into components and regenerating k-factors each time. Multiple parameter factors may be adjusted to vary the COTS reliability estimate based on, for example, engineering assessments, handbook data and other information related to the operational and or environmental usage profile.

Once COTS reliability estimates are generated, model data may be provided to appropriate organizations for assessment. Typical such assessments include, for example, assessments against customer requirements, logistics impact, mission reliability, developmental contract cost and schedule to perform estimates and overall systems effectiveness.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

We claim:

1. A method of providing reliability estimates comprising the steps of:
a) identifying equipment for reliability analysis;
b) distilling identified said equipment into elements;
c) retrieving reliability statistics for each equipment element;
d) generating k-factors for said each element responsive to retrieved said reliability statistics;
e) generating reliability statistics for said identified equipment responsive to said generated k-factors; and
f) managing said identified equipment responsive to said generated reliability statistics.

2. A method as in claim 1, wherein said identified equipment includes a plurality of assemblies and the step (b) of distilling said identified equipment into said elements comprises:
i) identifying said plurality of assemblies; and
ii) identifying components forming each of said assemblies.

3. A method as in claim 2, wherein the step (c) of retrieving reliability statistics comprises retrieving reliability statistics for each identified assembly and for each identified component.

4. A method as in claim 3, wherein the retrieved reliability statistics are stored locally and retrieved from local storage.

5. A method as in claim 3, wherein the step (c) of retrieving reliability statistics further comprises retrieving usage profiles and environmental profiles for analogous equipment.

6. A method as in claim 1, wherein the step (e) of generating reliability statistics comprises applying generated said k-factors in a weighted average.

7. A method as in claim 1, wherein said equipment is commercially available, generated said reliability statistics indicate a mean time between fails for said commercially available equipment and the step (f) of managing said commercially available equipment comprises ordering replacement parts for said commercially available equipment.

8. A method as in claim 7, wherein said commercially available equipment is a computer system, and parts being ordered replacement computer systems.

9. An equipment reliability prediction system comprising:
component reliability data storage storing reliability data for components included in available off-the-shelf equipment;
profile storage storing usage and environmental profiles for analogous equipment and for assemblies and components in said analogous equipment;
means for generating a weighted average of design-to-environment reliability attributes for said assemblies and said components, a reliability estimate being provided for identified off-the-shelf equipment responsive to said weighted average; and
means for providing a quality assessment of said identified off-the-shelf equipment, support being provided for said identified off-the-shelf equipment responsive to said quality assessment.

10. An equipment reliability prediction system as in claim 9, wherein the means for generating the weighted average distils said identified off-the-shelf equipment into elements.

11. An equipment reliability prediction system as in claim 10, wherein the elements comprise assemblies forming the off-the-shelf equipment and components forming the assemblies.

12. An equipment reliability prediction system as in claim 9, wherein the environmental profiles comprise statistical characterizations for vibrations, transportation effects, acoustics, shock, operating temperature, storage temperature, relative humidity, absolute humidit), sand and dust, salt air/water, and fungus:

13. An equipment reliability prediction system as in claim 9, wherein the means for providing a quality assessment comprises:
a life cycle cost tool;
a support cost model;
a risk assessment tool; and
a reliability model.

14. A program product for providing reliability estimates for off-the-shelf equipment, said computer program product comprising a computer usable medium having computer readable program code thereon, said computer readable program code comprising:
computer readable program code means for distilling equipment identified for reliability analysis into elements;
computer readable program code means for retrieving reliability statistics for each equipment element;
computer readable program code means for generating k-factors for said each element responsive to retrieved said reliability statistics; and
computer readable program code means for generating reliability statistics for said identified equipment responsive to said generated k-factors.

15. A program product for providing reliability estimates for off-the-shelf equipment as in claim 14, wherein said identified equipment includes a plurality of assemblies and the computer readable program code means for distilling said identified equipment into said elements comprises:
computer readable program code means for identifying said plurality of assemblies; and
computer readable program code means for identifying components forming each of said assemblies.

16. A program product for providing reliability estimates for off-the-shelf equipment as in claim 15, wherein the computer readable program code means for retrieving reliability statistics comprises computer readable program code means for retrieving reliability statistics for each identified assembly and for each identified component.

17. A program product for providing reliability estimates for off-the-shelf equipment as in claim 16, wherein the computer readable program code means for retrieving reliability statistics further retrieves usage profiles and environmental profiles for analogous equipment.

18. A program product for providing reliability estimates for off-the-shelf equipment as in claim 14, wherein the computer readable program code means for generating reliability statistics comprises computer readable program code means for generating a weighted average of said k-factors.

19. A program product for providing reliability estimates for off-the-shelf equipment as in claim 14, further comprising.
computer readable program code means for managing said identified equipment responsive to said generated reliability statistics.

20. A program product for providing reliability estimates for off-the-shelf equipment as in claim 19, wherein said computer readable program code means for generating reliability statistics comprises a spreadsheet, generated said reliability statistics indicate a mean time between fails for said off-the-shelf equipment and the computer readable program code means for managing said commercially available equipment comprises computer readable program code means for ordering replacement parts and replacement equipment.
